(19) United States
(12) Patent Application Publication
(10) Pub. No.: US 2001/0015370 A1
(43) Pub. Date: Aug. 23, 2001

(54) Friction stir welding method

(76) Inventors: Tetsuya Matsunaga, Kudamatsu (JP); Hideo Takai, Hikari (JP); Yuji Hosoda, Chiyoda (JP); Masakuni Ezumi, Kudamatsu (JP); Kazushige Fukuyori, Kudamatsu (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/788,494

(22) Filed: Feb. 21, 2001

(30) Foreign Application Priority Data
Feb. 21, 2000 (JP) 2000-42290

(51) Int. Cl. B23K 20/12; B23K 31/02; B23K 37/00

(52) U.S. Cl. 228/112.1; 228/2.1

(57) ABSTRACT

A butted portion of face plates 12b and 22b of two hollow extruded frame members 10 and 20 is carried out the friction stir welding from an upper portion. Next, a connection member 30 for connecting the upper portion face plates 12b and 22b is arranged. A connection of the connection member 30 and face plates 11 and 21 is carried out the friction stir welding from an upper portion with a condition they are supported by a backing plate 210. Since a load during the friction stir welding time is supported by the backing plate 210, ribs 13 and 14 can be formed thin and a light structure can be attained. In the friction stir welding of the hollow extruded frame members, the thickness of the rib of the welding portion can be reduced.

### BACKGROUND OF THE INVENTION

1. Technical Field

The present invention relates to a friction stir welding and a friction stir welding of a hollow shape extruded frame member and a friction stir welding apparatus, a structure body, and a friction stir welding use hollow extruded frame member. For example, the present invention is suitable to a friction stir welding method of an aluminum alloy hollow extruded frame member such as a railway vehicle, an air plane, a building structure and the like and a friction stir welding apparatus, a structure body, and a friction stir welding use hollow extruded frame member.

2. Prior Art

A friction stir welding method is a method in which by rotating a round rod (it is called as “a rotary tool”) which is inserted into a welding portion and moving the rotary tool along to a welding line, and the welding portion is heated, softened and plastically fluidized and is solid-stately welded.

The rotary tool is comprised of a small diameter portion which is inserted into the welding portion and a large diameter portion which is positioned at an outside of the small diameter portion. The small diameter portion and the large diameter portion of the rotary tool have the same axis. A boundary between the small diameter portion and the large diameter portion of the rotary tool is inserted a little into the welding portion. The above stated technique is disclosed, for example in Japanese application patent laid-open publication No. Hei 9-309164 (EP 0797043 A2).

During the friction stir welding time according to the rotary tool, the large load acts on a hollow extruded frame member to be subjected to the welding. For this reason, when the hollow shape extruded frame members are welded, a rib is provided to a welding portion, and the above stated load is supported according to this rib. Accordingly, the weight of the hollow shape extruded frame member becomes large, in the field of a railway vehicle and an air plane in which the light weight structure is aimed at, the increase in the weight becomes a large problem.

### SUMMARY OF THE INVENTION

An object of the present invention is to provide a friction stir welding wherein the weight increase in a hollow extruded frame member can be reduced and is to obtain an object for reducing the weight increase in a hollow extruded frame member.

The above stated object can be attained by a friction stir welding method, characterized in that in a rear face of a welding portion of a first member which is put on a frame stand and a second member for welding the first member, arranging a backing plate in a space which is haven by at least the first member, from an outer portion of the space, by forming the backing plate face and the frame stand as a support member, carrying out a friction stir welding to the first member and the second member, and removing the backing plate from the space.

### BRIEF DESCRIPTION OF THE DRAWING

FIG. 1 is a longitudinal cross-sectional view showing before a welding of a welding portion of a friction stir welding method of one embodiment according to the present invention;

FIG. 2 is a side view showing a welding apparatus of a friction stir welding method of one embodiment according to the present invention;

FIG. 3 is a longitudinal cross-sectional view showing a hollow shape extruded frame member to be subjected;

FIG. 4 is a perspective view showing a car body of a railway vehicle;

FIG. 5 is a side view showing a welding apparatus of a friction stir welding method of another embodiment according to the present invention;

FIG. 6 is a longitudinal cross-sectional view of a backing plate of a friction stir welding method of another embodiment according to the present invention;

FIG. 7 is a longitudinal cross-sectional view showing a welding portion of a friction stir welding method of another embodiment according to the present invention;

FIG. 8 is a longitudinal cross-sectional view showing a welding portion of a friction stir welding method of a further embodiment according to the present invention; and

FIG. 9 is a longitudinal cross-sectional view showing a welding portion of a friction stir welding method of a furthermore embodiment according to the present invention.

### DESCRIPTION OF THE INVENTION

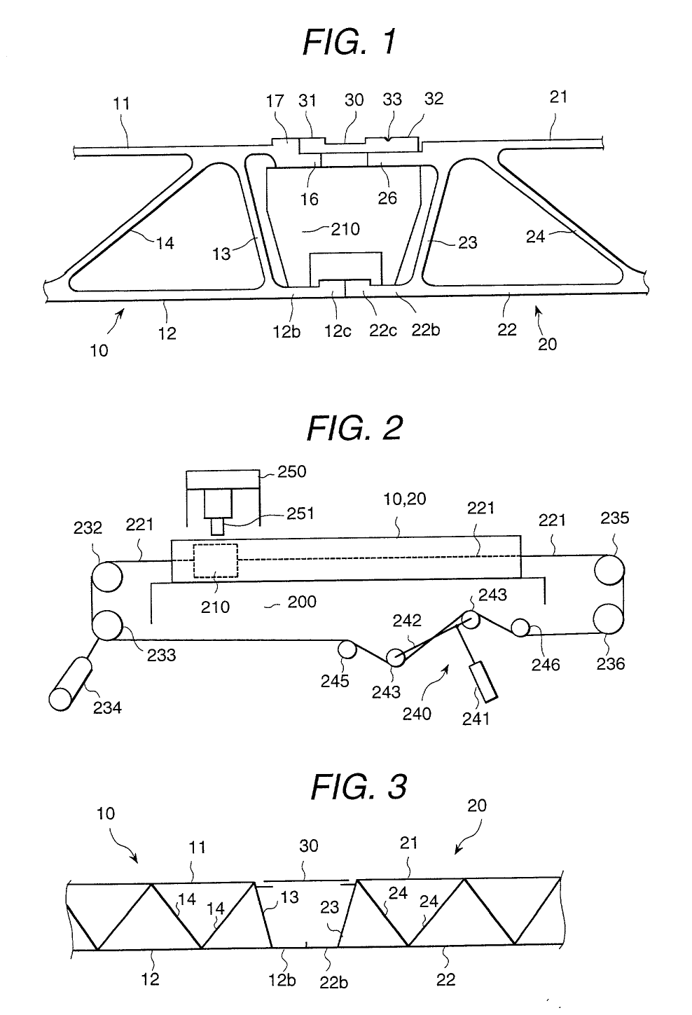

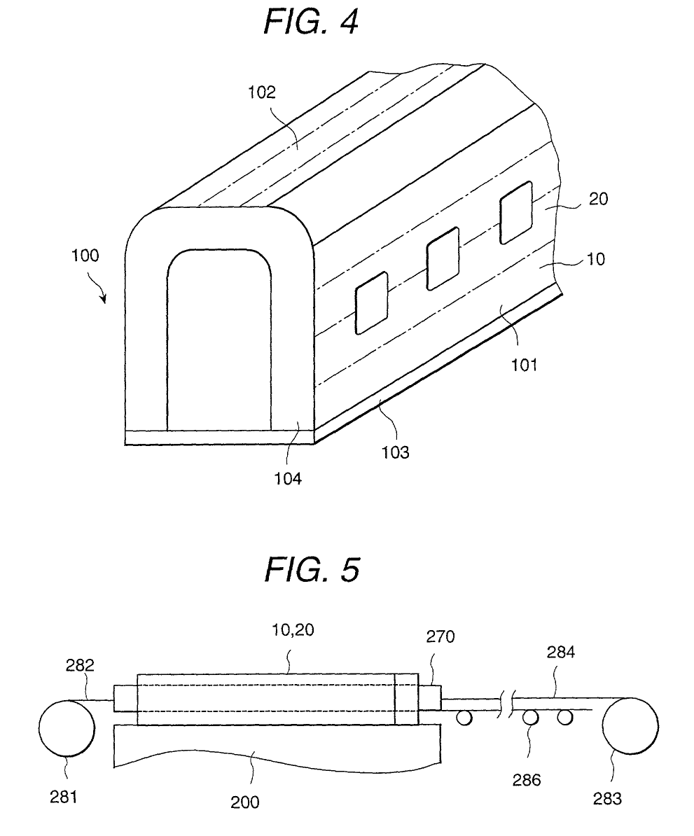

One embodiment according to the present invention will be explained referring to from FIG. 1 to FIG. 4. FIG. 3 is a cross-sectional view of III-III of FIG. 4. A railway vehicle structure body 100 is comprised of a side structure body 101 for constituting a side face, a roof structure body 102 for constituting a roof, a stand frame 103 for constituting a floor, and a side structure body 104 for constituting an end portion. Each of the side structure body 101, the roof structure body 102, and the frame stand 103 is constituted respectively by welding plural hollow extruded frame members. A longitudinal direction of the hollow extruded frame member is formed toward a longitudinal direction of a car body of a railway vehicle. The hollow extruded frame member is a hollow extruded frame member made of an aluminum alloy. A structure of hollow extruded frame members 10 and 20 for constituting the side structure body 101 will be explained. Other portions and other structure bodies are similar to the above.

The hollow extruded frame member 10 is comprised of two sheet face plates 11 and 12, and plural ribs 13 and 14 for connecting the above stated two face plates 11 and 12. The face plates 11 and 12 are substantially in parallel. The ribs 13 and 14 are inclined. The ribs 13 and 24 are arranged with a truss structure.

The hollow extruded frame member 20 is comprised of two sheet face plates 21 and 22 and plural ribs 23 and 24 for connecting the above stated two face plates 21 and 22. The face plates 21 and 22 are substantially in parallel. The ribs 23 and 24 are inclined. The ribs 23 and 24 are arranged with a truss structure.

An end portion of the face plate 12 which is positioned at an outer face of the car body 100 of the railway vehicle is projected to a side of the adjacent hollow extruded frame member 20 from an end portion of the face plate 12 of an inner side of the car body 100. This projected face plate at the end portion is called as 12b. A plate thickness of the face plate 12b is thicker than a plate thickness of the another portion face plate. To an end portion of the face plates 12b, a raised portions 12c which is projected to an upper portion is provided. The end portion of the face plate 12b including the raised portion 12c is butted and is carried out according to a friction stir welding.

An end portion of the face plate 22 which is positioned at an outer face of the car body 100 of the railway vehicle is projected to a side of the adjacent hollow extruded frame member 10 from an end portion of the face plate 22 of an inner side of the car body 100. This projected face plate at the end portion is called as 22b. A plate thickness of the face plate 22b is thicker than a plate thickness of the another portion face plate. To an end portion of the face plate 22b, a raised portion 22c which is projected to an upper portion is provided. The end portion of the face plate 22b including the raised portion 22c is butted and is carried out according to a friction stir welding.

A sum-up width of the two raised portions 12c and 22c is larger than a diameter of a large diameter portion of a rotary tool. A boundary portion of the large diameter portion of the rotary tool and a small diameter portion of the large diameter portion of the rotary tool is positioned in the upper portion raised portions 12c and 22c from an upper face of the face plates 12b and 22b.

The end portion of the face plate 11 and the end portion of the face plate 21 are connected according to a connection member 30. To the end portion of the face plate 11, a recessed portion is provided. The recessed portion is opened in an inner side of the car and a side of the end portion. To constitute the recessed portion, a chip 16 is projected to the side of the end portion. To the end portion of the face plate 11, a recessed portion, which is projected to the upper portion, is provided. To the end portion of the face plate 11 including the raised portion 17, an end portion of the connection member 30 is butted. Further, the end portion of the connection member 30 is overlapped to the projection chip 16. The above stated butted portion is carried out the friction stir welding from the upper portion. A position for carrying out the friction stir welding is positioned in an upper portion of the face plate 12b.

The butted portion (the position for carrying out the friction stir welding) of the face plate 11 and the connection member 30, namely a corner portion for reaching from the face plate 11 to the projection chip 16 is positioned at the upper portion of the face plate 12b.

To the end portion of the connection member 30, a raised portion 31 is provided. A sum-up width of the two raised portions 17 and 31 is larger than the diameter of the large diameter portion of the rotary tool. An insertion position of the large diameter portion of the rotary tool is similar to that of the case of the butted portion of the face plates 12b and 22b.

To the end portion of the face plate 21, a recessed portion is provided. The recessed portion is opened to the inner side of the car and a side of the end portion. To constitute the recessed portion a chip 26 is projected in the side of the end portion. The end portion of the connection member 30 is overlapped to the projection chip 26. This overlapped portion is carried according to the friction stir welding. The position of the friction stir welding is arranged on the upper portion of the face plate 22b. The connection portion between the upper face of the projection chip 26 and the upper face of the face plate 22 is inclined. This becomes a groove in the case of welding of the connection member 30 and the face plate 22.

The recessed amount of the projection chips 16 and 26 is the same to the thickness of the connection member 30. The upper face of the connection member 30 and the upper face of the face plates 11 and 12 is formed with the same face.

To the end portion of the connection member 30 in the side of the face plate 21, a raised portion 32, which projects to the upper portion, is provided. A width of the raised portion 32 is larger than the diameter of the large diameter portion of the rotary tool. To a center of the width of the raise portion 32, a V form groove 33 is arranged. According to the detection of the groove 33 by an optical system sensor and at the position of the groove 33 the rotary tool is induced. The welding of the butted portion is detected the position of the butted portion and the rotary tool to the butted portion is induced. An insertion amount of the large diameter portion of the rotary tool is similar to that of the case of the butted portion of the face plates 12b and 22b.

When the connection member 30 is carried out the welding, in a space in which the end portions of the two hollow extruded frame members 10 and 20 a backing plate 210 is arranged. The backing plate 210 is mounted on the face plates 12b and 22b. An upper face of the backing plate 210 is positioned at a lower portion of the welding portion. A height of the backing plate 210 is smaller than a height of between the upper face of the face plates 12b and 22b and the lower face of the projection chips 16 and 26. A gap between the both faces is not large. To the lower portion of the projection chips 16 and 26, the upper face of the backing plate 210 is positioned. To the lower portion of the position (the butted portion (the end portion of the connection member 30), the groove 33) of the friction stir welding, the backing plate 210 and the face plates 12b and 22b are provided. Accordingly, when the both ends of the connection member 30 are not carried out the welding at the same time, the backing plate 210 is not fallen down violently. The space for arranging the backing plate 210 exists in the rear face of the welding portion.

The procedure of the friction stir welding will be explained. First of all, the frame members 10 and 20 are mounted on a frame stand 200 and fixed. The face plates 11 and 21 are provided at the upper portion and the face plates 12 and 22 are provided at the lower portion. The face plates 12b and 22b are butted.

Next, using the space between the hollow extruded frame members 10 and 20 of the upper portion of the face plates 12b and 22b, the friction stir welding is carried out from the upper portion. In other words, from the upper portion the rotary tool is inserted into the butted portion and the friction stir welding is carried out. To the face plates 12b and 22b the raised portions 11c and 22c are provided, a gap of the butted portion is buried. The lower face of the face plates 12b and 22b is welded substantially flatly. The above stated space is constituted by the face plates 12b and 22b, the ribs 13 and 23, and the ribs 11 and 21.

During the above stated friction stir welding line, buries caused by the welding and the raised portions 12c and 22c are cut off. The rotary tool installs a cutter at an outer face in a radial direction of the large diameter portion. Using this cutter, the buries are cut off. Further, the upper portion of the raised portions 12c and 22c is cut off. Next, the cut-off chips are removed.

Next, to the space in which the end portion of the hollow extruded frame members 10 and 20 constituted the backing plate 210 is arranged. In FIG. 2, the welding is carried out directing from the left side to the right side. To the outside from the right side of the hollow extruded frame members 10 and 20, the backing plate 210 is provided, having this backing plate 210 by the hand the backing plate 210 is mounted on the face plates 12b and 22b of the left end of the hollow extruded frame members 10 and 20. To the left end of the backing plate 210 a left end chain 221 is connected. By pulling the backing plate 210 by the hand through a rope, the backing plate 210 is moved for direct to the right end. The left end chain 221 is entered into the end portion of the hollow extruded frame members 10 and 20. When the backing plate 210 is moved to the right end, the right end chain 221 is connected to the right end of the backing plate 210.

On an extension line of the left and the right of the above stated space, sprockets 232 and 235 are mounted respectively. The chain 221 is arranged with an endless form through the backing plate 210. A reference numeral 240 is a means for pulling or slacking the chain 221. When a rod of a cylinder means 241 is projected, a link 242 rotates and the chain 221 is pulled up. To both ends of the link 242, sprockets 243 and 244 for supporting the chain 221 are provided. Reference numerals 245 and 246 indicate sprockets.

When the chain 221 is slacked or the backing plate 210 is came off from the chain 221 and the like, to prevent the come-off of the chain 221 from the sprocket, rollers are provided at a vicinity of the necessary sprockets. By these sprockets and the roller, the chain 221 is sandwiched. Reference numerals 233 and 236 indicate sprockets.

A reference numeral 250 is a friction stir welding means having a friction stir welding use rotary tool 251. The friction stir welding means 250 is stridden over the stand frame 200. The friction stir welding means 250 is moved along to the frame stand 200. The rotary tool 251 can move in an upper direction and a lower direction.

When the chain 221 is connected to the backing plate 210, and the backing plate 210 is mounted on the face plates 12b and 22b, according to the pulling and slacking means 240 the chain 221 is pulled. To an upper face and a lower face of the backing plate 210, the oils and fats are coated. Or, to the upper face of the face plates 12b and 22b, and to the lower face of the projection chips 16 and 26, the oils and fats are coated. A length of the backing plate 210 is several 10 cm degree. The backing plate 210 is made by a ferrite system.

Next, the connection member 30 is mounted on the projection chips 16 and 26. A side of the raised portion 31 of the connection member 30 is butted to the end portion of the face plate 11. Next, the connection member 30 is fixed temporally to the face plates 11 and 21. The temporary fixing welding is carried out intermittently. Or, by pressing the connection member 30, the connection member 30 is restrained.

Next, by inserting the rotary tool 251 from the upper portion, the friction stir welding is started from a side of the above stated one end. The side of the face plate 11 is the butt welding to the face plate 11 and the connection member 30. The side of the face plate 12 is made the overlap welding to the projection chip 26 and the connection member 30. The projection chips 16 and 26 are bent a little in the lower portion during the welding.

The rotary tool 251 begins to start the move direct for the left end, by a drive machine 234 the sprocket 233 is rotated and the backing plate 210 is moved. The backing plate 210 is moved by synchronizing with the move of the rotary tool 251. Since the backing plate 20 is pulled from the both sides, the backing plate 210 is moved easily by synchronizing with the move of the rotary tool 251.

The welding of the both ends of the connection member 30 has finished, by operating the means 240 the chain 221 is slackened. Next, the interconnection between the right portion of the backing plate 210 and the right end chain 221 is released. The right end chain 221 is removed by the hand.

Next, in the outside of the left end of the hollow extruded frame members 10 and 20, the left chain 221 is pulled up by the hand, and the chain 221 and the backing plate are pulled down from the space.

With the above stated construction, the load acted on the projection chips 16 and 26 according to the rotary tool 251 are supported according to the stand frame 200 through the backing plate 210 and the face plates 12b and 22b. Namely, since the face plates 12b and 22b are applied to the stand frame 200 and the backing plate 210 is applied to the face plates 12b and 22b and the face plates 11 and 21 (the projection chips 16 and 26) are applied to the backing plate 210, the backing plate 210 and the like become the support members during the friction stir welding. Accordingly, the projection chips 16 and 26, the face plates 11 and 21 at the vicinity are not bent largely, and further the ribs 13 and 14, and 23 and 24 are not deform largely. Accordingly, the plate thickness of the ribs 13 and 23 can be formed thin. As a result, the hollow extruded frame members 10 and 20 can be formed with the light structure and the structure body having the light weight structure can be obtained.

To weld the butted portion between the face plate 11 and the connection member 30, since the projection chip 16 is unnecessary. However, the projection chip 16 is provided, the softened metal does not contact to the backing plate 210. Further, the insertion amount of the rotary tool 251 is excessive, since there is afford to have the thickness of the projection chip 16, the rotary tool 251 hardly contacts to the backing plate 210. Accordingly, the backing plate 210 hardly welds to the hollow extruded frame member 10. As a result, the backing plate 210 can be moved easily. Further, since the projection chip 16 is provided, the oils and the fats can not contact to the welding portion.

Along to the move direction of the backing plate 210, caterpillars are wound to the backing plate 210, the move of the backing plate 210 can carry out easily. The caterpillars are divided into the left portion and the right portion.

Referring to FIG. 5, another embodiment of the backing plate will be explained. During the friction stir welding time, a backing plate 270 is not moved. A length of the backing plate 270 is longer a little than a length of the hollow extruded frame members 10 and 20. After the welding of the face plates 12b and 22b, from a left side winch 281, a rope 282 (it may as well do a chain) is drawn and the rope 282 is arranged in a space and is connected to a left end of the backing plate 270 which is laid on a right side roller 286 of the frame stand 200. Using the winch 281, the backing plate 270 is pulled and is mounted on the face plates 12b and 22b. This condition is shown in FIG. 5.

After the friction stir welding, the rope 282 is taken off from the backing plate 270. Next, according to the right end winch 283, the backing plate 270 is pulled in a side of the right end and drawn and mounted the roller 286. The winch 283 and the backing plate 270 are connected through the rope 284 (it may as to do the chain).

The backing plate 270 which has lifted up a crane may be inserted to the space from the upper portion. At immediately before the space, the backing plate 270 is inserted with an inclination state to the space.

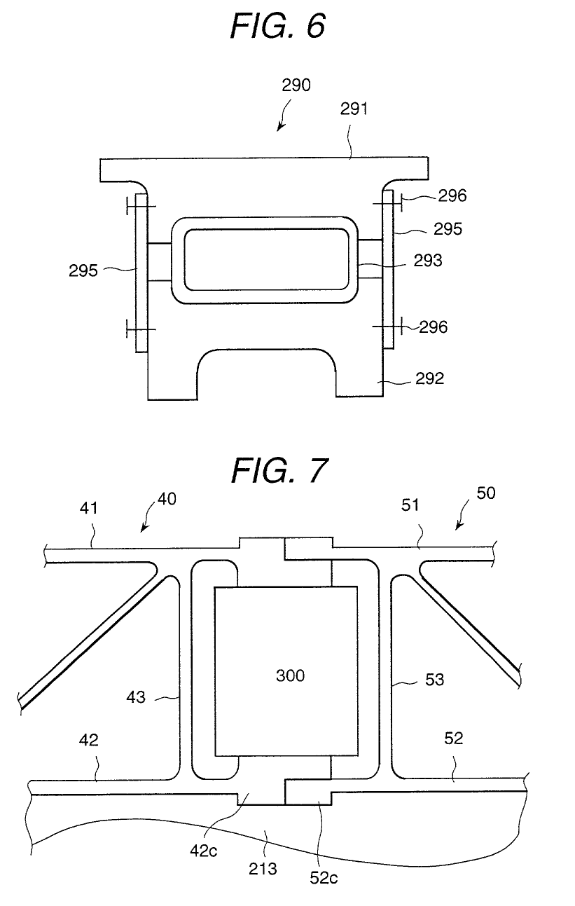

An embodiment of FIG. 6 will be explained. A backing plate 290 is an improved one of the backing plate 270. The backing plate 290 is comprised of an upper portion block 291, a lower portion block 292, an air back 293 arranged between the both blocks 291 and 292. A weight of the upper portion block 291 is larger than a weight of the lower portion block 292. Between the both blocks 291 and 292 in a side face are connected by links 295, pins 296 and 297. To an upper portion of the link 295, a long hole in which the pin 296 can move in an upper and in a lower direction is provided. This link 295 and the like are arranged intermittently in a longitudinal direction of the backing plate 290. The air back 294 is arranged in a longitudinal direction of the lower portion block 292. A length of the backing plate 290 is similar to a length of the backing plate 270. The air back 293 is comprised of a hose.

The use methods of the backing plate 290 are following two methods. One of them resides in that after the friction stir welding of the connection member 30, the air is entered to the air back 293 and the upper portion block 291 is ascended. The projection chips 16 and 26 which have bent in the lower portion are bent to the upper portion. Next, the air is discharged from the air back 293. According to the weight of the upper portion block 291, this upper portion block 291 can be separated and be detached from projection chips 16 and 26. According to the demands, the upper portion block 291 may strike in a hammer in the lower portion. According to this, a gap can occur easily between the upper portion block 291 and the projection chips 16 and 26. Accordingly, the backing plate 290 can be pulled easily.

Another of them resides in that before the welding according to the air back 293 the upper portion block 291 is ascended. It is preferable the above stated process to carry out after the temporal welding of the connection member 30. With this condition, the friction stir welding of the connection member 30 is carried out. After the friction stir welding, the air is discharged from the air back 293. Hereinafter is carried out with the above stated manner.

Since the lower portion block 292 is provided, the air back 293 is not contacted to the raised portions 12c and 22c, the damage of the air back 293 can be prevented.

An embodiment of FIG. 7 will be explained. Two face plates 51 and 52 of a hollow extruded frame member 50 are butted to a recessed portion of an end portion of the two face plates 41 and 42 of the hollow extruded frame member 40. The respective face plates 51 and 52 is carried out according to the friction stir welding from an outer portion of the hollow extruded frame member 50. The respective face plates 41 and 42 is carried out according to the friction stir welding from an outer portion of the hollow extruded frame members 40. The upper and lower butted portions are positioned from projected from ribs 43 and 53. A backing plate 300 is mounted on lower portion projection chip 42c, the backing plate 300 can support the upper portion projection chip 41c. The rib 43 is orthogonal to the face plates 41 and 42. The rib 53 is orthogonal to the face plates 51 and 52. The face plates 51b and 52b of the hollow extruded frame member 50 are overlapped to the projection chips 41c and 42c. The lower faces of the hollow extruded frame members 40 and 50 are mounted on a frame stand 213.

The working procedure will be explained. To a space of an end portion of the hollow extruded frame member 40 which is laid on the frame stand 213, a rope 282 (shown in the embodiment of FIG. 5) is entered. Next, the hollow extruded frame member 40 is butted. And the butted portion is carried out according to the temporary fixing welding.

Next, according to the rope 282, the backing plate 300 is pulled in the space which are formed by the two hollow extruded frame members 40 and 50. When the welding portion is enable to be supported according to the backing plate 300, from the upper portion the friction stir welding is carried out. Next, another end rope 284 of the backing plate 300 is pulled and then the backing plate 300 is drawn. The combination of the backing plate 300 and the rope 282 is released. The rope 282 remains to be inserted in the space.

Next, the rope 282 which is provided to the outside from the left end of the hollow extruded frame members 40 and 50 is separated into two in the left direction and the right direction. Next, a structure body which is comprised of the welded hollow extruded frame members 40 and 50 is carried out reversibly in an upper portion and a lower portion. The rope 282 remains to be entered in the space. Next, the ropes 282, which are separated in the left direction and the right direction, are connected each other. Further, the rope 282 and the backing plate 300 are connected.

Next, by drawing the rope 282, the backing plate 300 is entered again in the space. Next, from the upper portion the friction stir welding is carried out. Next, the combination of the rope 282 and the backing plate 300 is released. Next, by pulling the rope 284 the backing plate 300 is drawn.

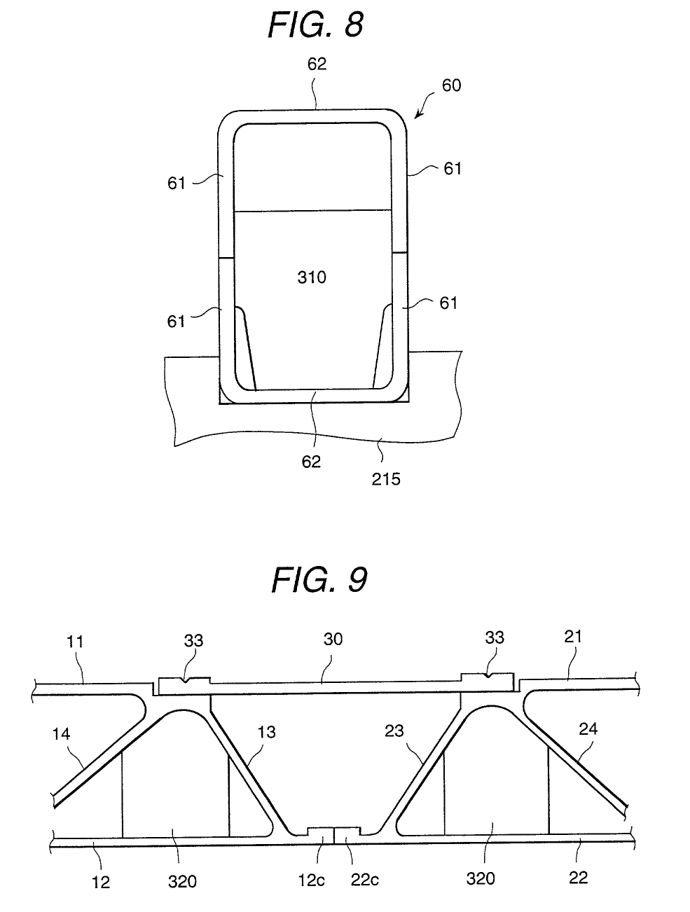

An embodiment of FIG. 8 will be explained. The members 60 and 60 to be subjected are C shape hollow extruded frame members. The member 60 is comprised of substantially parallel two chips 61 and a chip 62 for connecting one end of the above stated chips 61. An butted portion of another end of the chips 61 and 61 of one hollow extruded frame member 60 of another end of the chips 61 and 61 of another hollow extruded frame member 60 is carried out according to the friction stir welding. To a space of the butted hollow extruded frame members 60 and 60, a backing plate 310 is entered. By laying the butted portion at a side, the hollow extruded frame members 60 and 60 are mounted on the frame stand 215. The backing plate 310 is entered from the upper portion by a crane. The frame stand 215 has a recessed portion to form the positioning the lower portion hollow extruded frame member 60. The friction stir welding can be carried out at the same time from the left direction and the right direction.

An embodiment of FIG. 9 will be explained. In this embodiment according to the present invention, to a closed space a backing plate 320 is arranged. The backing plate 320 is similar to the backing plate 270 or the backing plate 290. An upper end of the backing plate 320 has a circular shape which corresponds to a shape of a rear face of a welding portion. To an apex of a truss structure of the end portion of the hollow extruded frame member 10, the welding portion of the connection member 30 and the hollow extruded frame members 10 and 20 is provided. The apex of the truss structure exists on an extension line of a normal line in a thickness direction of the frame member. The truss structure is comprised of the ribs 13 and 14 and the face plate 12. The truss structure is comprised of the ribs 23 and 24 and the face plate 22. The both ends of the connection member 30 are carried out according to the overlap welding. Accordingly, the inclination angle of the ribs 13 and 23 can reach to that of the ribs 14 and 24.

The upper portion of the backing plate 320 may be formed with a circular shape hose. A diameter of the hose is a size which can contact to a circular arc of the rear face of the welding portion. The air pressure of the hose is set larger that the air pressure of the lower portion air back. Further, by jetting the high pressure air from the lower portion of the backing plate 320 into direct in the lower portion, the backing plate 320 can be supported.

A technical range according to the present invention is not limited by the wordings defined in each claim of what is claimed is or the wordings stated on the means for solving the problems and further it refers also to the range in which the man belonged in this technical field can be placed easily.

According to the present invention, since the load during the welding time is burdened by the backing plate, the plate thickness of the hollow extruded frame member can be reduced, accordingly the light weight structure of the hollow extruded frame member can be attained.

What is claimed is:

1. A friction stir welding method, characterized in that
in a rear face of a welding portion of a first member which is put on a frame stand and a second member for welding said first member, arranging a backing plate in a space which is haven by at least said first member;
from an outer portion of said space, by forming said backing plate and said frame stand as a support member, carrying out a friction stir welding to said first member and said second member; and
removing said backing plate from said space.

2. A friction stir welding method according to claim 1, characterized in that,
said space is constituted by said first member and said second member.

3. A friction stir welding method according to claim 1, characterized in that,
said space is constituted by only said first member.

4. A friction stir welding method according to claim 1, characterized in that,
said backing plate is support by at least said first member.

5. A friction stir welding method, characterized in that
in a rear face of a welding portion of a first member which is mounted on a frame stand and a second member for welding said first member, mounting a backing plate on a first plate of said first member in a space which is haven by at least said first member;
carrying out a friction stir welding to said first member and said second member which are positioned in an upper portion of said backing plate from said upper portion; and
removing said backing plate from said space.

6. A friction stir welding method according to claim 5, characterized in that,
drawing said backing plate in a welding line direction of the friction stir welding, and mounting said backing plate on said first member.

7. A friction stir welding method according to claim 5, characterized in that,
after said backing plate is mounted on said first member, by ascending said backing plate, and by ascending a plate of a welding side of said first member and a portion of said second member to be welded a plate of said first member;
carrying out the friction stir welding;
after the friction stir welding, descending said backing plate; and
pulling out said backing plate.

8. A friction stir welding method according to claim 7, characterized in that,
carrying out said ascent of said backing plate by pouring air in an air back; and
carrying out said descent of said air back by drawing the air from said air back.

9. A friction stir welding method according to claim 5, characterized in that,
by ascending said backing plate, ascending said welded portion of said first plate of said first member and said second member; and
descending said backing plate.

10. A friction stir welding method according to claim 9, characterized in that,
carrying out said ascent of said backing plate by pouring the air in an air back; and
carrying out said descent of said air back by drawing the air from said air back.

11. A friction stir welding method according to claim 5, characterized in that,
forming a respective said fist member and said second member in C shape cross-section, and mounting a chip at a center of said first member on said frame stand by forming said chip in a lower portion of other two chips;
in a space which is constituted by said each chips of said first member, mounting on said backing plate from an upper portion;
combining said second member with said first member; and
carrying out the friction stir welding from a lateral portion.

12. A friction stir welding method, characterized in that,
by mounting said first plate of said first member and said first plate of said second member on a frame stand, and combining said first plate of said first member and said first plate of said second member them with a condition to be welded;
carrying out a friction stir welding said first plates each other using a rotary tool from an upper portion;
by mounting a backing plate on a respective said first plates, positioning said backing plate in a lower portion of said first member which is positioned in an upper portion of a respective first plate and a respective second plates of said second member, and further positioning said backing plate in a lower portion of a connection member for welding said respective second plates;
carrying out a friction stir welding both end portions of said connection member which is positioned in an upper portion of said backing plate to said respective first plates from an upper portion; and
pulling said backing plate.

13. A friction stir welding method according to claim 12, characterized in that,
in said backing plate, positioning a contact portion of said backing plate and said first plate in a lower portion of a welding portion of both ends of said connection member and said second plate.

14. A friction stir welding apparatus comprising:
a frame stand for mounting a first member and a second member;
in a rear face of a portion in which said first member and said second member are welded, a backing plate arranged in a space of at least said first member;
a drive means for pulling said backing plate through a chain or a rope from one end from and another end of a welding line; and
a friction stir welding means for moving along to said frame stand and for welding said first member and said second member mounted on said frame stand from an upper portion;
said friction stir welding means comprising characterized in that
said chain or said rope in a side of said one end and said backing plate are formed attachable and detachably.

15. A structure body comprising:
a first member having a first plate, a second plate substantially parallel to said first plate, and a rib for connecting said first plate and said second plate; and
a second member having a first plate, a second plate substantially parallel to said first plate, and a rib for connecting said first plate and said second plate;
the structure body characterized in that said first plate of said first member and said first plate of said second member are welded according to a friction stir welding;
between said second plate of said first member and said second plate of said second member, a connection member is provided;
both ends of said connection member are welded to said second plate of said first member and said second plate of said second member according to the friction stir welding; and
when said first plate is laid in a lower portion from said second plate, in an upper portion of said first plate which is arranged between a connection portion of said rib and said first plate and said welded portion of said first plate, said welded portion of said connection member and said second plate is provided.

16. A structure body comprising:
a first member having a first plate, a second plate substantially parallel to said first plate, and a rib for connecting said first plate and said second plate; and
a second member having a first plate, a second plate substantially parallel to said first plate, and a rib for connecting said first plate and said second plate;
the structure body characterized in that said first plate of said first member and said first plate of said second member are welded according to a friction stir welding from an outer side;
said second plate of said first member and said second plate of said second member are welded according to a friction stir welding from an outer side;
when said first plate is laid in a lower portion from said second plate, in an upper portion of said first plate which is arranged between said welded portion of said first plates each other and a respective said ribs, said welded portion of said second plates each other and a respective said ribs, said second plate is provided.

17. A friction stir welding use extruded frame member comprising:
a first member having a first plate, a second plate substantially parallel to said first plate, and plural ribs for connecting said first plate and said second plate;
the friction stir welding use extruded frame member characterized in that
a respective end portions of said first plate and said second plate is projected in a side of an end portion from said rib; and
when said first plate is laid in a lower portion from said second plate, in an upper portion of said projected first plate, said projected second plate is provided.

18. A friction stir welding use extruded frame member according to claim 17, characterized in that
to said end portion of said projected second plate, a recessed portion which is recessed in a side of said first plate is provided;
in said end portion of said second plate, to constitute said recessed portion, a projection chip for projecting to direct for said side of said end portion is provided; and
said projected chip is arranged in an upper portion of said projected first plate.

19. A friction stir welding use frame member according to claim 17, characterized in that
said end portion of said projected first plate is projected in said side of said end portion from said end portion of said second plate.

20. A friction stir welding use frame member according to claim 19, characterized in that
to said end portion of said projected second plate, a recessed portion which is recessed in a side of said first plate is provided;
in said end portion of said second plate, to constitute said recessed portion, a projection chip for projecting to direct for said side of said end portion is provided; and
said projected chip is arranged in an upper portion of said projected first plate.
